(19) United States
(12) Patent Application Publication
(10) Pub. No.: US 2024/0388145 A1
(43) Pub. Date: Nov. 21, 2024

(54) ELECTRIC MACHINE COMPRISING A HOUSING

(71) Applicant: Innomotics GmbH, Nümberg (DE)

(72) Inventor: THOMAS CEPEK, Berlin (DE)

(73) Assignee: INNOMOTICS GMBH, Nümberg (DE)

(21) Appl. No.: 18/696,718

(22) PCT Filed: Sep. 30, 2022
(86) PCT No.: PCT/EP2022/077353

§ 371 Date: Mar. 28, 2024

(30) Foreign Application Priority Data
Sep. 30, 2021 (EP) 21200260.4

(51) Int. Cl. H02K 1/18

(52) U.S. Cl. CPC H02K 1/18

(57) ABSTRACT

An electric machine includes a stator and a housing. The stator includes a laminated stator core and a first stator-side coupling element located at a height of an axis of the electric machine in an area of the laminated core. The first stator-side coupling element includes a first slot. The stator includes annular stator elements accommodating the first stator-side coupling element. The housing includes a first housing-side coupling element located at the height of the axis of the electric machine in an area of the laminated core and having a second slot. Screw connections provide a connection between the first stator-side coupling element and the first housing-side coupling element, and a key forms part of the connection between the first stator-side coupling element and the first housing-side coupling element. The stator is aligned in relation to the housing by at least two keys.

The invention relates to an electric machine. The electric machine has a housing, the machine housing.

An electric machine is for example a motor or a generator. Electric machines can be synchronous machines or asynchronous machines. The electric machine has electrical conductors in an active part. The active part is for example a stator or an armature of the electric machine. The armature of the electric machine can also have permanent magnets for example and thus in particular be a passive part. The stator of the electric machine has electrical conductors. The stator of the electric machine is in a housing of the electric machine. The armature of the electric machine is supported by means of bearings. The bearing or the bearings is or are accommodated in the housing of the electric machine.

In an electric machine main modules are to be connected to one another so that desired operating parameters are safely achieved. Main modules of an electric machine are for example the stator, the armature, the housing or the bearings. In an electric machine the stator can be welded into the machine housing, whereby vibrations and body noise can be transmitted to the housing structure. If the machine housing is fastened to a system, vibration dampers can be attached below the feet of the machine housing, so that the machine housing and the stator connected rigidly to the machine housing can be decoupled to some extent from the rest of the system.

A connection of main modules relates in this case to the coupling, i.e. the connection of stator and machine housing (housing of the electric machine). Via this connection, which represents a coupling of stator and housing, static or dynamic forces are transmitted from the stator to the machine housing or vice versa. Furthermore the precise alignment of the stator in relation to the machine housing is also to be guaranteed with the coupling. Since the rotor axis is also aligned to the machine housing on the machine housing via the bearing receptacles and bearings, the coupling of stator and machine housing thus also has an influence on the alignment of stator and rotor. The rotor can also be referred to as the armature. The coupling of stator and machine housing is in particular a foundation for an effective operation of the electric machine within the framework of the required operating parameters. Possible operating parameters in this case relate for example to vibrations, a stiffness, an imbalance and/or an alignment of the axis of the armature. According to applicable international and/or national standards, electric machines have to comply in particular with verified vibration values during operation. These in particular result in specific requirements about the stiffness of the machine housing and in particular of the bearing receptacle integrated therein.

One object of the invention is to improve the connection between main modules of the electric machine. Advantageously this relates for example to the improvement of the vibration characteristics of the electric machine.

The object is achieved for example by an electric machine as claimed in claim 1. Further embodiments emerge for example in accordance with claims 2 to 11.

An electric machine has a housing and a stator, wherein the stator has a first stator-side coupling element and the housing has a first housing-side coupling element, wherein the first stator-side coupling element and the first housing-side coupling element are at the height of the axis of the electric machine and wherein the first stator-side coupling element and the first housing-side coupling element are in the region of the stator core. The height of the axis relates in this case to the position of the axis of rotation of the rotor of the electric machine. In this case in particular the position with regard to a distance from a plane to which the electric machine is able to be attached is to be considered. The area of the stator core relates in particular to an area between end plates of the stator core. The end plates are each on the end face side of the stator core. The area thus relates to a position along a longitudinal alignment of the electric machine, i.e. along the axis of rotation. The electric machine in particular has four connections between coupling elements. In this case the housing in particular has four housing-side coupling elements. The stator in particular has at least two or also four or more stator-side coupling elements. A stator-side coupling element has two connections for example, wherein one of the connections in each case represents a connection to a housing-side coupling element. Two connections between the coupling elements are in particular mirror-symmetrical to the axis of rotation of the electric machine. One of the variants described above or below of the connection between stator and housing of the electric machines produces an advantageous coupling of stator and machine housing (housing) in electric machines. Thus the placement of stators in the machine housing for example in which shims have to be used can be avoided, wherein the stator can be aligned by means of shims and can be attached by screws in the machine housing. The attachment in this case takes place in a vertical alignment to the armature axis. For this additional components would be needed on the stator. These might possibly lead on the one hand to the flow or forces being less favorable and on the other hand can result in the excitation of vibrations from the stator into the machine housing. Furthermore additional components such as shims can lead to the need for additional handling apparatus in the manufacturing process. The coupling of stator and housing by means of stator-side and housing-side coupling elements enables the flow of forces from stator to machine housing to be optimized. In particular, this also produces what is known as a “decoupling” of the transfer of vibrations from them stator into the machine housing. In this case the coupling part of the stator conveys the vibrations of the stator during operation to the coupling part of the base frame of the housing.

In one embodiment of the electric machine the connection between the first stator-side coupling element and the first housing-side coupling element has screw connections. These types of connection are easy to release again. In a further embodiment, it is also possible for connections or welded connections to be used instead, or in a combined manner. The coupling of stator and machine housing is undertaken in particular by the screwing together of stator and machine housing in a horizontal alignment to the rotor axis. The alignment is undertaken in this case for example by one or more keys. The first stator-side coupling element has a first slot and the housing-side coupling element has a second slot. A key is then positioned in particular in these slots. For example with four housing-side coupling elements, these four each have a slot. A key is positioned in this slot in each case. The keys in particular also engage in respective slots of stator-side coupling elements. A stator-side coupling element is in particular held and/or positioned by two annular stator elements. Annular stator elements comprise the laminated core of the stator in the circumferential direction.

In one embodiment of the electric machine the connection between the first stator-side coupling element and the first housing-side coupling element thus in particular has a key, wherein in particular the stator is aligned to the housing by means of at least two keys. The respective key is in particular in the slot of the respective housing-side coupling element and in the respective slot of the stator-side coupling element. These slots of the coupling elements belonging to one another in particular lie opposite one another. The first stator-side coupling element is in particular accommodated in the annular stator elements. A key can for example be provided for just one connection in each case. In a further embodiment a key can be provided for at least two or more connections. A key only extends for example over the length of the respective connection. In a further embodiment a key extends for example from one connection to a second connection located in an axial direction. The axial direction is produced in this case from the direction or alignment of the axis of rotation of the electric machine. In one embodiment of the electric machine the stator-side coupling element has a slot to accommodate the key. Likewise, in one embodiment of the electric machine, the housing-side coupling element also has a slot to accommodate the key. The stator-side coupling element is for example a bar with a rectangular profile, wherein the bar extends over the axial length of the stator. In this case the rectangular bar can be held in annular elements, which are distributed over the axial length of the stator. In one embodiment of the connections between stator and housing with a key the transmission of forces and moments between stator and housing, in particular a base frame of the housing, can in particular also take place via the key connection and not for example solely through a screw connection. By means of the key very high forces can be accepted, which can occur for example in the event of a short circuit. With the use of keys a slot for the key can be inserted in each case into the coupling parts of stator and base frame for example. The key also serves at the same time to establish an exact alignment of stator and base frame, in order in turn to guarantee an exact alignment of stator and rotor. The screw connections to one another additionally present in coupling parts serve to fix the connection and in particular not in each embodiment of the electric machine for transmission of forces and moments. The use of keys for an alignment of the stator in the housing (i.e. in particular in the base frame of the housing) also enables additional components to be dispensed with and also savings to be made in additional handling apparatuses in the manufacturing process.

In one embodiment of the electric machine the first housing-side coupling element and a second housing-side coupling element each have a connection to the first stator-side coupling element. This enables a correct alignment of the stator to be achieved more easily in a simple manner.

In one embodiment of the electric machine the first stator-side coupling element is accommodated in an annular element of the stator (an annular stator element). In particular the stator-side coupling element is accommodated in a plurality of annular elements. This too facilitates the alignment of the stator.

In one embodiment of the electric machine the stator is fastened, i.e. accommodated, in the housing by means of at least four connections between housing-side coupling elements and stator-side coupling elements, wherein the at least four connections span planes through a planar embodiment, wherein the axis of rotation of the electric machine is in a space between planes lying opposite one another. The axis of rotation is thus also located in the space that stretches between the surfaces of the housing-side coupling. The axis of rotation thus runs at least partly through this spanned space.

The connections are thus located at approximately the height of the axis of rotation of the electric machine. This increases the stability or stiffness of the fastening of the stator in the housing.

In one embodiment of the electric machine at least one housing-side coupling element is connected to a foot point of the housing. The foot point of the housing is in particular the area that is provided for fastening the electric machine, to a foundation for example. The connection of the housing-side coupling element to the foot point of the housing enables the weight force of the stator to be conveyed into this foot point in a simple way. The connection between housing-side coupling element and the foot point of the housing is thus in particular made directly. Through this design of the coupling of stator and machine housing the flow of force from stator to machine housing is optimized. This also produces what is known as a “decoupling” of the transfer of vibrations from the stator into the machine housing. In this case the coupling part of the stator (stator-side coupling element) transfers the vibrations of the stator during operation to the coupling part of the base frame (housing-side coupling element). Since this is in particular only fixed in the area of the connection of stator and base frame of the housing or in the foot point on the base frame of the housing, it can act as a damping spring. So that the weight forces from the stator can be accepted and the coupling part is supported on the base frame (housing-side of the coupling element), a stabilization part (stabilization element) is in particular connected to the housing-side coupling element in the head and foot point of this element by welding.

In one embodiment of the electric machine said machine thus in particular has at least one housing-side coupling element with a stabilization element, wherein the stabilization element is connected to the housing-side coupling element. These two elements are in particular attached at right angles to one another and increase the stability.

In one embodiment of the electric machine the housing has a base element and a cover element. These segmentations of the housing enable the stator to be installed in the housing easily. The base element in this case is provided for fastening the electric machine to a body such as a foundation for example. The base element in particular features the housing-side coupling elements.

In one embodiment of the electric machine the housing has a double-walled bearing receptacle. A double-walled bearing receptacle is in particular advantageous for a vibration-critical electric machine. Machine housings can also be embodied in the area of the bearing receptacle with a thick steel plate, which are additionally provided for example with a few stiffening ribs on the inner side. A thick steel plate for the bearing receptacle leads to a high weight of the housing for example. A further disadvantage of just one heavy and thick steel plate for the bearing receptacle of the bearing or the bearing of the electric machine can be that even with the stiffening ribs, there is no guarantee that the required vibration values can be adhered to. If necessary further stiffening elements are to be fitted after the machine has been tried out. These problems can be avoided by a double-walled bearing receptacle. The two walls of the bearing receptacle are in particular separated by a distance that corresponds to the axial extent of the bearing.

In one embodiment of the electric machine the double-walled bearing receptacle has at least two walls. A double-walled bearing receptacle can thus also have three or more walls, since this has at least two walls. Such a bearing receptacle with two or more walls can also be referred to as a multi-wall bearing receptacle. The double-walled bearing receptacle enables the stiffness of the bearing receptacle to be increased. Thus this advantageous embodiment of the bearing receptacle in particular enables the use of extra material to be kept within limits.

In one embodiment of the electric machine there is stiffening between the first wall (walls) and the second wall (walls) of the double-walled bearing receptacle. This increases the stability. In one embodiment of the electric machine the stiffening has a plurality of ribs. This also enables the stiffness to be increased. In a further embodiment of the electric machine the stiffening has a plurality of plates. The plates are between the walls and are permanently connected to these walls. This also enables the stiffness to be improved and influenced.

In one embodiment of the electric machine the bearing is also connected to one wall of the double-walled bearing receptacle. This connection is in particular rigid. The wall is in particular the end-face wall in each case. An increase in the stiffness is produced by the double-walled embodiment of the bearing receptacle, even for just one wall.

As regards the stiffness of the housing and thus the vibration behavior of the electric machine, there can be an advantageous connection between different measures. Thus a double-walled bearing receptacle can advantageously be linked to one of the variants of the use of coupling elements for fastening of the stator in the housing. The axial position of coupling elements can also play a role here.

The invention will be described in greater detail and explained below with the aid of the exemplary embodiments shown in the figures. In the figures:

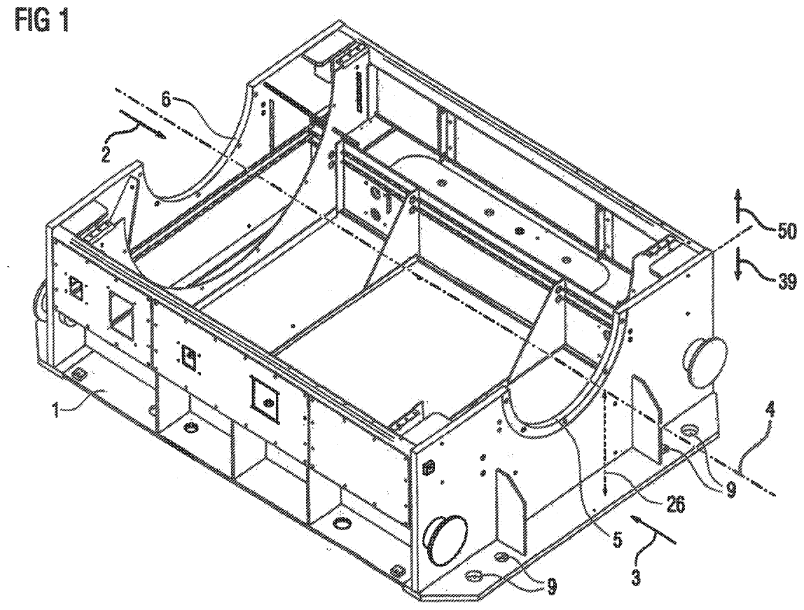

FIG. 1 shows a part of a housing of an electric machine,

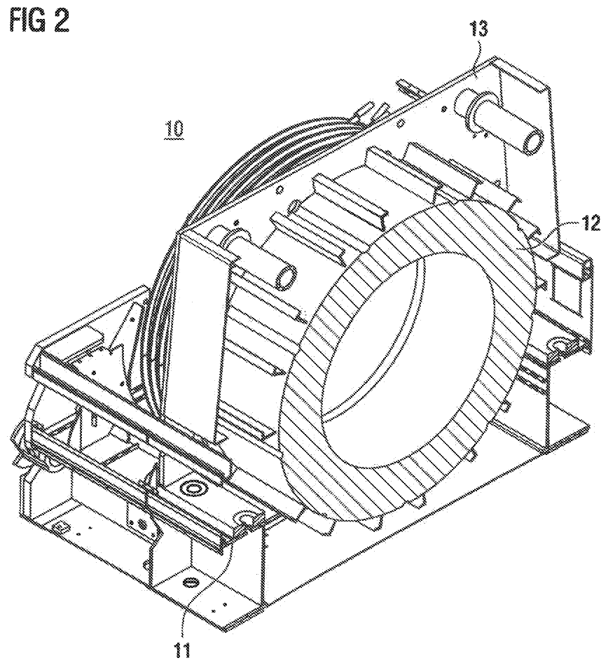

FIG. 2 shows an interface component of an electric machine,

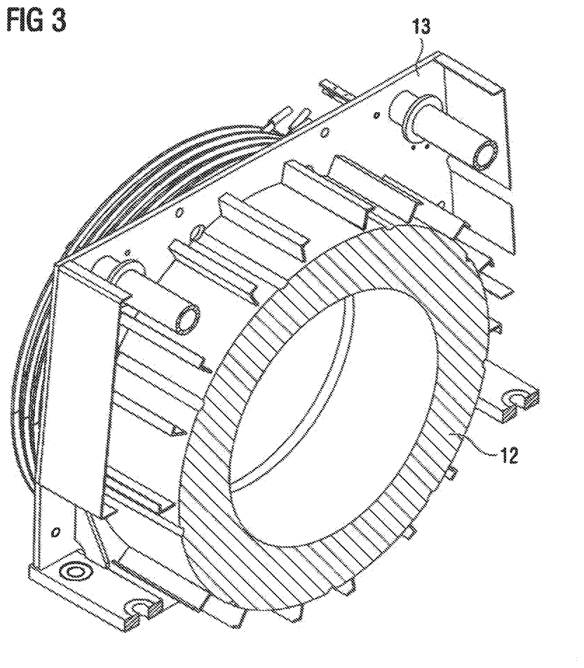

FIG. 3 shows a detailed view from FIG. 2,

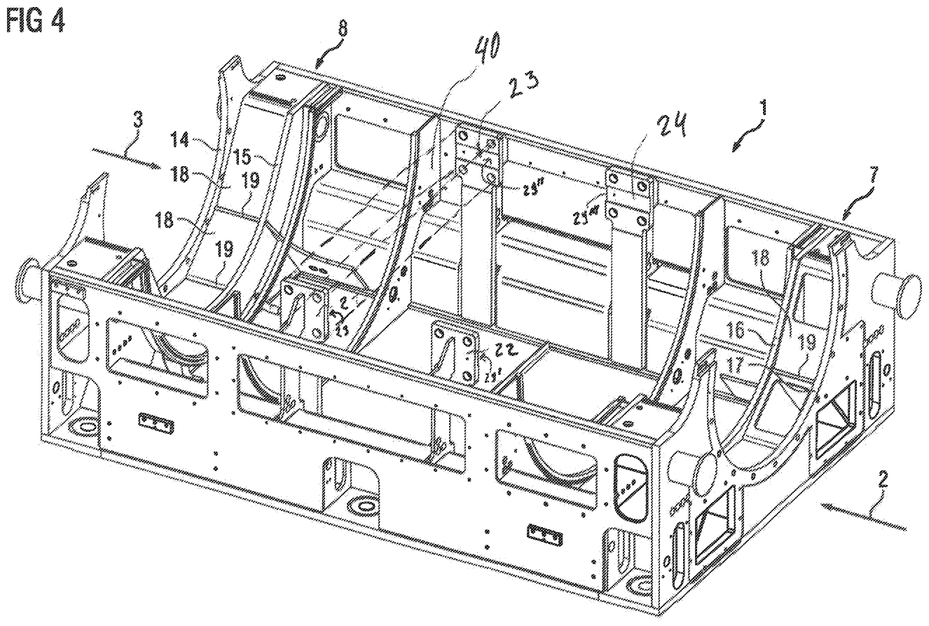

FIG. 4 shows a double-walled bearing receptacle,

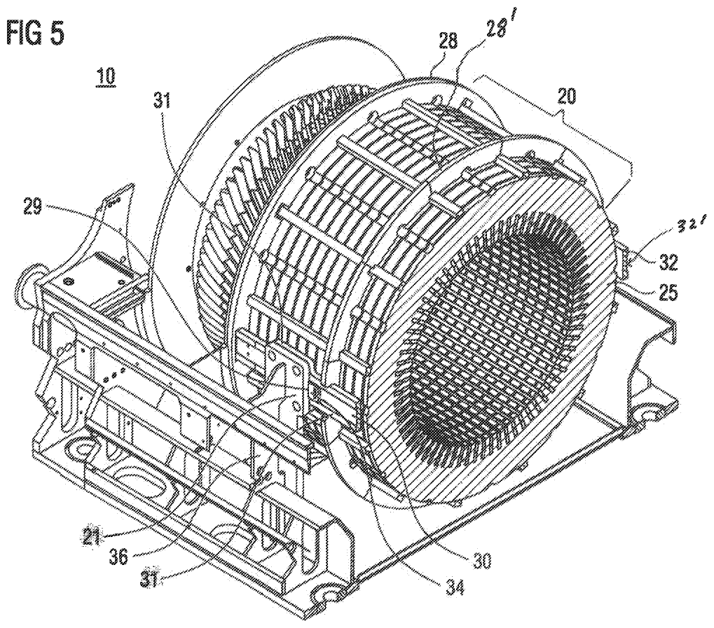

FIG. 5 shows a sectional diagram of the electric machine,

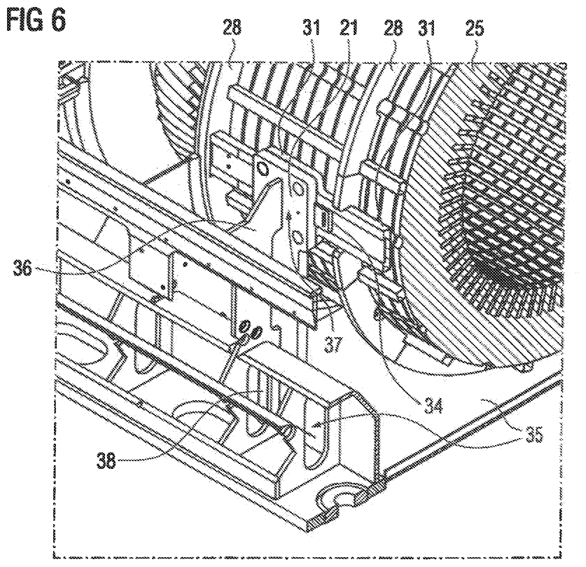

FIG. 6 shows a detailed view of a housing from FIG. 5 and

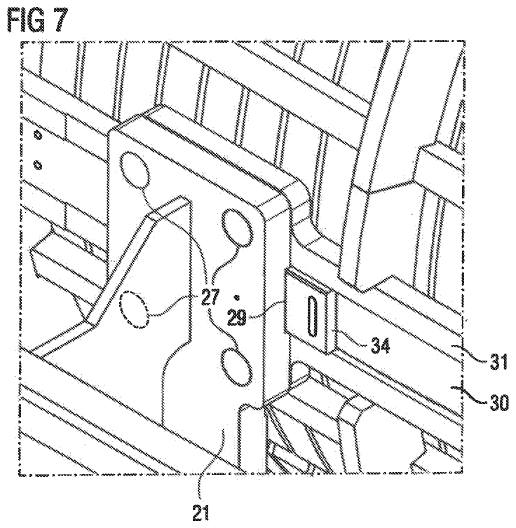

FIG. 7 shows a detailed view of a housing from FIG. 6.

The diagram depicted in in FIG. 1 shows a part of a housing 1 of an electric machine. The housing has a first end face side 2 and a second end face side 3. The part of the housing 1 shown for a housing divided into two is the base element in area 39. Located in area 40 is the cover element 40, wherein this cover element 40 is not shown in FIG. 1. The response axis 4 of the electric machine is located at an axis height 26. Further shown is a first bearing receptacle 5 and a second bearing receptacle 6. These are designed as single-walled parts. Holes 9 in the area of the foot point of the electric machine enable the machine to be attached.

The diagram depicted in FIG. 2 once again shows a section of the electric machine, and indeed shows an interface component 11 in detail, by means of which a base frame 13 for the stator 12 is positioned.

The diagram depicted in FIG. 3 shows a section from FIG. 2, wherein the focus is on base frame 13 and stator 12.

The diagram depicted in FIG. 4 shows a double-walled bearing receptacle 7 and 8 with first walls 14 and 16 in each case and second walls 15 and 17 in each case. The stiffness of the double-walled bearing receptacle 7 and 8 is increased by ribs 19 and plates 18. The double-walled design of the bearing receptacle on the machine housing enables a much higher degree of stiffness to be achieved. The bearing receptacle thus prevents a greater tendency of the bearing to vibrate through excitations from the armature or through vibrations of the stator. This design makes it possible, by way of two walls with optimized material strength and the stiffening ribs located between them, for the bearing receptacle to be made much stiffer, without the weight of the housing increasing significantly. As an alternative a bearing receptacle with a thicker bearing wall and additional thicker stiffening ribs would be possible.

Regardless of the bearing receptacle, FIG. 4 also shows four housing-side coupling elements 21, 22, 23 and 24, which each have a slot 29, 29′, 29″ and 29′″. This slot serves to accommodate a key, which is not shown in FIG. 4. The key is also accommodated in a slot in the associated stator-side coupling element, wherein this is shown by way of example in FIG. 5 for the coupling elements 21 and 31. The first stator-side coupling element 31 has a first slot 30 there and the housing-side coupling element 21 has a second slot 29. The coupling elements 21 and 31 thus each have slots 29 and 30 for accommodating a key 34. A housing-side coupling element 21 can be connected via screw connections (four holes are shown for this) to the stator-side coupling element 31 (the screws are not shown). The four connections (21, 22, 23, 24), i.e. the coupling elements, have a planar embodiment, whereby planes are spanned. A space 40 is produced by the surfaces of opposing housing-side coupling elements. Located at least partly in this space 40 of planes lying opposite one another is the axis of rotation of the electric machine, i.e. in sections. This description enables it to be understood that the axis of rotation is located at the same height as the coupling elements.

The diagram depicted in FIG. 5 shows a sectional diagram of the electric machine 10. The stator has a stator core 25. This is connected via annular stator elements 28, 28′ to stator-side coupling elements 31, 32. A stator-side coupling element 31 is held in each case by at least two annular stator elements 28 and 28. The coupling elements 31 and 32 each have a slot 30 or 32′.

The coupling elements 31, 32, 21 are located in the area of the stator core 20. A housing-side coupling element 21, 22, 23, 24 (all four are shown in FIG. 4) can be connected via screw connections (four holes are shown for these) to the respective stator-side coupling element 31 (the screws are not shown). The stator-side coupling element 31 shown in FIG. 5 is able to be connected to the housing-side coupling element 21. The first housing-side coupling element 21 is connected to a stabilization element 36. The coupling elements 21 and 31 have slots 29 and 30 for accommodating a key 34.

The diagram depicted in FIG. 6 shows the coupling depicted in FIG. 5 in detail. The foot point 35 is also shown in relation to the housing 1 of the electric machine and the foot part 38 and the head part 37 of the housing-side coupling element 21 and thus also the head part and the foot part of the stabilization element 36, which is connected in the head area and in the foot area to the housing-side coupling element and is at right angles to said element.

The diagram depicted in in FIG. 7 shows a further detailed view of the coupling. The diagram in particular shows how the key 34 engages in the slots 29 and 30. Four holes 27 are provided for screw connections, wherein only three are shown.

1.-11. (canceled)

12. An electric machine, comprising:
a stator comprising a laminated stator core and a first stator-side coupling element located at a height of an axis of the electric machine in an area of the laminated core, said first stator-side coupling element comprising a first slot, said stator comprising annular stator elements accommodating the first stator-side coupling element;
a housing comprising a first housing-side coupling element located at the height of the axis of the electric machine in an area of the laminated core, said housing-side coupling element comprising a second slot;
screw connections designed to provide a connection between the first stator-side coupling element and the first housing-side coupling element; and
a key forming part of the connection between the first stator-side coupling element and the first housing-side coupling element,
wherein the stator is aligned in relation to the housing by at least two of said key.

13. The electric machine of claim 12, wherein the housing comprises a second housing-side coupling element, each of the first housing-side coupling element and the second housing-side coupling element comprising a connection to the first stator-side coupling element.

14. The electric machine of claim 12, comprising at least four of said housing-side coupling element, wherein the stator is fastened by at least four connections between the at least four housing-side coupling elements and stator-side coupling elements in the housing, wherein the at least four connections have a planar configuration to span planes, with an axis of rotation of the electric machine lying in a space of planes in opposition to one another.

15. The electric machine of claim 12, wherein the housing-side coupling element is connected to a foot point of the housing.

16. The electric machine of claim 12, wherein the housing-side coupling element is connected to a stabilization element.

17. The electric machine of claim 12, wherein the housing comprises a base element and a cover element connectable to the base element.

18. The electric machine of claim 12, wherein the housing comprises a double-walled bearing receptacle.

19. The electric machine of claim 18, further comprising a stiffening structure designed to provide a stiffening between a first wall of the double-walled bearing receptacle and a second wall of the double-walled bearing receptacle.

20. The electric machine of claim 19, wherein the stiffening structure comprises a plurality of ribs.

21. The electric machine of claim 19, wherein the stiffening structure comprises a plurality of plates.

22. The electric machine of claim 18, further comprising a bearing rigidly connected to walls of the double-walled bearing receptacle.
